(19) United States
(12) Patent Application Publication
(10) Pub. No.: US 2006/0293425 A1
(43) Pub. Date: Dec. 28, 2006

(54) Method for producing functional polyimide fine particle and rewritable memory material utilizing change in fluorescence characteristics caused in fluorescence characteristics caused by light irradiation or heat treatment

(75) Inventors: Hachiro Nakanishi, Sendai-shi Miyagi (JP); Hitoshi Kasai, Sendai-shi (JP); Takayuki Ishizaka, Sendai-shi (JP)

Correspondence Address: HAHN & VOIGHT PLLC, 1012 14TH STREET, NW, SUITE 620, WASHINGTON, DC, 20005, US

(73) Assignee: Japan Science and Technology Agency, Saitama (JP)

(21) Appl. No.: 10/569,105

(22) PCT Filed: Feb. 26, 2004
(86) PCT No.: PCT/JP04/02273

§ 371 Date: Feb. 22, 2006

(30) Foreign Application Priority Data
Aug. 26, 2003 (JP) 2003-301774
Aug. 27, 2003 (JP) 2003-302322

(51) Int. Cl. C08K 3/10

(52) U.S. Cl. 524/403; 524/600

(57) ABSTRACT

A rewritable photomemory material obtained by combining a polymer possessing a carbonyl group in a main chain or a side chain with a function-imparting component such as a compound which produces rare earth ions is disclosed. The magnitude of fluorescence level of the rewritable phtomemory material can be intensified by light irradiation, while an initial state can be recovered by a heat treatment. Fine particle materials imparted with functions such as fluorescence characteristics, magnetic characteristics, coloration or non-linear characteristics are also disclosed, and particularly a fine particle material imparted with heat resistance through combination with polyimide is disclosed.

### FIELD OF THE INVENTION

The, present invention relates to a functional film prepared from a solution comprising a functional component and a polymer constituent, a functional particle with not less than 5 nm and not more than 10000 nm in diameter which comprises a polymer constitute containing a functional component prepared by re-precipitation method from the solution and a method for preparation of said particles from a solution containing the polymer and the functional component by re-precipitating said functional particle by the prepared solution being poured into a solvent which is poor solvent to said polymer and functional component. More in detail, the present invention relates to a photomemory material comprising a polymer with a carbonyl group to which an ion of element belonging to rare-earth elements, especially lanthanides, is contained as a function providing component, a polymer film containing an ion of rare-earth elements possessing a photomemory characteristic produced by using an ion of said rare-earth elements and a solution of said polymer, or a polymer film containing an ion of said rare-earth elements formed from polymer fine particles containing an ion of rare-earth elements possessing a photomemory characteristic produced by reprecipitation and with particle size in diameter from 5 nm to 10000 nm or from a solution containing said polymer fine particles. Since said polymer film, fine particles or fine particle film are characterized that magnitude of fluorescence level intensifies along with the increase of photo irradiation energy, in other words, along with the increase of the product of irradiation intensity×irradiation time, while the magnitude of fluorescence level decreases to the initial state along with the elevation of temperature of heat treatment, said polymer film, fine particles or fine particle film can be used as a rewritable photomemory material which utilizes said change of fluorescence. Further, the present invention relates to a method to produce a polyimide fine particle possessing said rare-earth ion, transition metal ion or pigment, in particular, an polyimide particle with particle size in diameter from 5 nm to 10000 nm by forming polyamide acid fine particles pouring a solution of polyamide acid containing a compound which forms a rare-earth ion or a transition metal ion or a solution of polyamide acid in which a pigment is dissolved in a poor solvent so as a polyamide acid fine particles possessing said rare-earth ion, transition metal ion or pigment to be formed by a reprecipitation method, then imidizing said polyimide fine particles possessing said rare-earth ion, transition metal ion or pigment.

### BACKGROUND OF THE ART

Along with the recent progress of informationalized society, a recording material which makes high density and high speed treatment possible is being required, and attempting the improvement of recording density by developing a recording medium which is possible to shorten the wavelength of light wavelength and makes narrow the width of a pit by said shortening of the wavelength. However, at the accomplishment of a high density recording medium, a multiple recording material which makes several bits recording par one pit possible is desired in stead of conventional one bit par one pit recording. Further, from the view point of requirement for the art gentle to environment, a material which has a characteristic of rewritable is required besides said recording characteristic. In Document 1, Shinya MAENOSONO, Ceco Danov DUSHKIN, Soichiro SAITA and Yukio YAMAGUCHI, “Optical Memory Media Based on Excitation-Time Dependent Luminescene from a Thin Film of Semiconductor Nanocrystal” Japanese Journal of Applied Physics 39, 4006-4012 (2000), there is following recitation reciting that a fine particle of CdSe whose surface is capped by tri-octylphosphine oxide prepared by adding a solution of dimethylcadmium, selenium-tri-butylphosphine to tri-octylphosphine oxide, maintaining the obtained solution at the temperature of 300° C. under argon atmosphere by constant stirring indicates 7 times stronger intensity to the initial magnitude of fluorescence level along with increase of irradiation time of laser light of 430 nm wavelength and 15 mW and saturated by 500 minutes and the intensity of intensified luminescence is stable more than 500 hours. However, there is no recitation reciting erasion of fluorescence. In Document 2, Masayuki Nogami, “Room temperature persistent spectral hole burning of Eu³⁺ ions doped in sol-gel derived glasses” Journal of Luminescence 98, 289-294 (2002), the author proposes that a hole is formed by irradiating Rhodamine 6G laser of spot size 1 mm to alminosilicate glass containing Eu³⁺ prepared by a sol-gel method at −196° C. (77 k) by 300 W, further, there is a passage stating that a hole is formed in a same way by irradiating X-ray at room temperature and depth of the hole can be reduced by elevating the temperature, and proposes that several bits record can be obtained by changing depth of a hole. In Document 3, Nobuhiko Umezu, Tsunenori Asatsuma, Yoshihiro Takemoto, Masahiro Kaneko “Multi-wavelength recording at room temperature by gated persistent spectral hole burning in SrFCl_{0.5}Br_{0.5}:Sm²⁺” Journal of Luminescene 64, 195-199 (1995), there is a record reporting that multi-wavelength recording is possible by forming many holes in an excitating spectrum of Sm²⁺ by irradiating pigment laser of multi-wavelength within the range from 688 nm to 693 nm to a powder of SrFCl_{0.5}Br_{0.5} containing a Sm²⁺ ion and make high density record possible. However, since the depth of hole reported in these documents are shallow and broad, a threshold value becomes vague.

Accordingly, these recording materials can not be said as a sufficient recording material which satisfies room temperature recording characteristic and high resolution characteristic which are required to a recording material in the informationalized society. Further, from the view point of productivity of a recording material, these recording materials can not be said as a sufficient one. In the meanwhile, a fine particle, in the present invention, a particle with particle size in diameter approximately from 50 nm-10000 nm is called as a fine particle, a fine particle of said form can be easily changed or processed to various shapes by joining the particles from one dimensional shape to three dimensional shape and is very easy for handling as a material, further, there are many production techniques of inorganic fine particle possessing a functionality. On the contrary, although polymer has an advantage that can be processed to a fine particle by mild condition by lower cost and is light weight, many polymers have problems of lower heat resistance, lower light resistance, lower chemical agent resistance and have a defect of inferior mechanical intensity. On the contrary, polyimide is an excellent polymer which does not have such defects and an investigation for making fine particle of polyimide is carried out, however, a technique to make a fine particle posses a functionality is not developed yet, accordingly, there is no idea to blend an component which provides the functionality to a solution for forming a polyimide fine particles. In Document 4, Jun Hu et al. Journal of Applied Polymer Science, 89, 1124-1131 (2003), an invention of a method for preparation of submicron PMMA particle containing rare earth ion by polymerizing rare earth ions and a monomer which forms said polymer under irradiation of microwave in the condition of not existing an emulsifier is recorded. Further, in Document 5, Katsuya Asao et al, Kobunshi ronbunshu, vol 57, No. 5, pp. 271-276, May 2000, in particular in items 2 and 3, preparation of polyimide fine particles, a method for preparation of polyimide fine particle comprising, producing polyamide acid, which is a precursor of polyimide, by reacting tetracarboxilic acid dianhydride and diamine in an aprotic polar solvent and obtaining polyimide fine particles as precipitation by adding toluene in said polyamide acid solution and refluxing so as to progress heat imidization reaction is disclosed. Still further, in Document 6, Abstract of Polymer Science annual forum, Vol. 50, No. 3 (2001), pp 484, III F08, Title “Preparation of polyimide fine particles by a reprecipitation method”, a method for preparation of polyimide fine particle using polyamide acid solution, which is a precursor of polyimide obtained by reacting tetra carboxylic acid dianhydride and diamine in an aprotic polar solvent, then producing polyimide fine particles by thermally or chemically imidizing above obtained fine particles of polyamide acid is disclosed. Furthermore, in Document 8, Japan Patent Publication 2003-84332 (published on Mar. 19, 2003), an invention of “A method for preparation of inorganic fine particle-organic crystal hybrid fine particle comprising; pouring an organic material having π-conjugated bond as a water soluble solution into aqueous dispersion in which inorganic fine particles of 50 nm or less selected from the compound group consisting of metal fine particles, semi-conductor fine particles, fine particles of inorganic fluorescent material and fine particle of inorganic luminescent material, are dispersed, co-precipitating said inorganic fine particle which forms a core into said organic material which forms a shell in said dispersion and forming shell of fine crystal of said organic material on the surface of the core of said inorganic fine particles of 50 nm or less by controlling the size of said inorganic fine particle and by controlling the adding amount of said organic material.” is disclosed and a method for preparation of hybrid nano particles consisting of inorganic fluorescence material fine particles or inorganic emission material fine particles and organic fine particles by a reprecipitation method using inorganic fluorescence material fine particles or inorganic emission material fine particles, specifically ZnS (refer to of the publication) or organic material, organic material which is possible of solid-state polymerization, specifically using diacetylene is disclosed. The author of the document refers the generation of interaction at the surface of both compounds by said hybrid fine particle.

However, document which refer to obtain fine particles prepared by making contain rare earth ions and pigment to polyimide resin, which is excellent in heat resistance, especially fine particles with particle size in diameter from 5 nm to 10000 nm is not found.

The first subject of the present invention is to provide a photomemory material which is characterized that the recorded memory is stable in room temperature, multiple recording of multiple bits for 1 pit is possible and rewriting of record is possible utilizing a change of fluorescence characteristic by light irradiation. The inventors of the present invention have found that an ion of elements of rare earth, especially, belonging to lanthanide, which is contained in polymer possessing carbonyl group, for example, imide group, carboxyl group or ester group thereof can enhance magnitude of fluorescence level of rare earth ion depending on photo irradiation amount, that is, irradiation intensity×irradiation time, especially, in a case of polyimide can enhance magnitude of fluorescence level 400 times in maximum, and luminescence intensity characteristic after light irradiation is stopped is stable for several months at room temperature, and have found that high density record can possible by providing various thresholds of irradiation amount. Further, the inventors of the present invention have accomplished the elimination of magnitude of fluorescence level by putting back to initial state by heat treatment, utilizing flexible structure of polymer. Furthermore, the inventors of the present invention have found that after elimination of fluorescence, magnitude of fluorescence level can be intensified again by irradiation of light depending on light irradiation amount. Since above mentioned photomemory is possible not only by a film but also by a shape of fine particle of 5 nm size, the inventors of the present invention have found that high resolution record is possible and have accomplished the 1^{st} subject of the present invention.

The second subject of the present invention is to provide fine particles of polyimide possessing fluorescence, non-linear and luminescence characteristics using polyimide resin which is superior in heat resistance, especially, to provide fine particles of 5 nm-10000 nm particle size indiameter. For the accomplishment of said 2^{nd} subject of the present invention, the inventors of the present invention have a conception as follows. As the first step, by containing a compound or a dye forming rare earth ion or transition metal ion which provides said functionality to polyimide resin at a production process of fine particles, a functionality providing material can be existed in a state that said functionality is provided stable in fine particles or in a state to generate a new function by hybrid with polyimide, producing a material for hybrid fine particle composed of polyamide acid and a rare earth ion or a transition metal ion by re-precipitation method from a solution of a compound or a dye which forms said rare earth ion or transition metal ion with polyamide acid which is a precursor of polyimide resin. Then, a material for hybrid fine particle composed of a rare earth ion, a transition metal ion or a dye and a polyimide resin is obtained by crosslinking the polyimide resin by well-known crosslinking means in the technical field of the art, for example, heating or chemical crosslinking method. Fluorescence characteristic etc of polyimide resin containing rare earth ion are investigated, and the usefulness of the material for hybrid fine particle composed of polyamide acid and a rare earth ion can be confirmed. Further, it is understood that fine particles possessing coloring characteristic and non-linear characteristic of said dye can be obtained from a dye and polyimide resin, and in hybrid fine particles composed of polyimide resin and a transition metal resin, fine particles having characteristics based on the characteristic of transition metal that the particle size is uniform, for example, in a case of nano size fine particles indicates a characteristic which generates a quantum effect can be provided. As mentioned above, the second subject of the present invention is accomplished.

### DISCLOSURE OF THE INVENTION

The first invention relating to the first subject is,
(1) a photomemory material comprising a polymer with a carbonyl group in a main or a side chain of the polymer containing rare earth element ion characterized in which magnitude of fluorescence level is intensified corresponding with applied photo irradiation intensity and is able to restore to initial state by applying heat treatment.
   In detail, desirably,
(2) the photomemory material as described in said (1), wherein the polymer possessing a carbonyl group is a polyimide obtained by a reaction of tetracarboxylic acid or di-anhydride thereof with diamine, or, (3) the photomemory material as described in said (1), wherein the polymer possessing a carbonyl group is a polymer possessing a carboxylic group or an ester group thereof in a said side chain, further desirably, (4) the photomemory material as described in said (3), wherein the polymer possessing a carboxylic group or an ester group thereof in a said side chain is a polymer obtained by an addition polymerization of ethylene unsaturated group, furthermore desirably, (5) the photomemory material as described in said (1), (2), (3) or (4), wherein the rare earth element is selected from the group consisting of elements whose atomic number is 58 or more and 70 or less.

The second invention relating to the first subject is,
(6) relates to a photomemory material is polymer fine particles containing a rare earth element ion with particle size indiameter from 5 nm to 10000 nm obtained by a method which comprise of a step obtaining a solution containing said polymer and said rare earth element ion by dissolving a polymer possessing a carbonyl group in a main or a side chain of the polymer and a compound of the rare earth element which forms the rare earth element ion into a solvent which dissolves said two components, and a step pouring said solution dissolving said two components into a poor solvent which poorly dissolves said two components and re-precipitating said two components to obtain said polymer fine particles, and related to a polymer film or a bulky molded product obtained by a method which comprise of a step obtaining the solution containing said polymer and said rare earth element ion by dissolving a polymer possessing a carbonyl group in a main or a side chain of the polymer and a compound of the rare earth element which forms the rare earth element ion into the solvent which dissolves at least said two components, the step pouring said solution dissolving two components into a poor solvent which poorly dissolves said two components and re-precipitateing said two components to obtain the solution containing polymer fine particles containing said rare earth element ion with the property of photomemory and particle size in diameter from 5 nm to 10000 nm, and the step forming the said polymer film or the bulky molded product composed of said polymer fine particles containing said rare earth element ion.

The first invention of said second subject is,
(2-1) a method for production of polyimide fine particles whose particle size is from 5 nm to 10000 nm containing a rare earth ion or a transition metal ion or a pigment comprising, pouring polyamide acid solution prepared by dissolving a compound which forms a rare earth ion or a transition metal ion or a pigment compound in a solution which forms said ions to a poor solvent to said rare earth ion or transition metal ion or the pigment compound and the polyamide acid, forming fine particles of polyamide acid containing the rare earth ion or the transition metal ion or the pigment, then carrying out imidizing treatment on the formed fine particles of polyamide acid.
   Desirably, the first invention of said second subject is,
(2-2) the method for production of polyimide fine particles whose particle size is from 5 nm to 10000 nm containing a rare earth ion or a transition metal ion or a pigment of (2-1) comprising, using polyamide acid solution dissolving a compound which forms 0.1-10 weight % of rare earth ion or transition metal ion or a pigment compound, more desirably, (2-3) the method for production of polyimide fine particles whose particle size is from 5 nm to 10000 nm containing a rare earth ion or a transition metal ion or a pigment of (2-1) or (2-2) comprising, using acetone, acetonitrile, tetrahydrofuran or chloroform as a solvent to prepare polyamide acid solution, furthermore desirably, (2-4) the method for production of polyimide fine particles whose particle size is from 5 nm to 10000 nm containing a rare earth ion or a transition metal ion or a pigment of (2-1), (2-2) or (2-3), wherein the poor solvent is decalin, cyclohexane, hexane, benzene, toluene, water, alcohols, CS₂ or mixture of two kinds or more, still further desirably, (2-5) the method for production of polyimide fine particles whose particle size is from 5 nm to 10000 nm containing a rare earth ion or a transition metal ion or a pigment of (2-1), (2-2), (2-3) or (2-4) wherein the temperature of the poor solvent is adjusted from −20° C. to 60° C., yet further desirably, (2-6) the method for production of polyimide fine particles whose particle size is from 5 nm to 10000 nm containing a rare earth ion or a transition metal ion or a pigment of (2-1), (2-2), (2-3), (2-4) or (2-5) wherein the rare earth element ion is an element selected from the group consisting of the element whose atomic number is 58 or more and 70 or less.

### BRIEF ILLUSTRATION OF THE DRAWING

FIG. 1 shows the correlation between irradiation time and magnitude of fluorescence level belongs to Eu³⁺, when light of 6 W and wavelength 254 nm is irradiated to a polyimide film containing Eu³⁺ obtained in Example 1 using an UV lamp.

FIG. 2 shows the correlation between heat treatment temperature of a polyimide film containing Eu³⁺ obtained in Example 1 when magnitude of fluorescence level is saturated by said UV irradiation and reduction of magnitude of fluorescence level. Fluorescence is eliminated perfectly at 200° C.

FIG. 3 shows the correlation between irradiation time when UV light is further irradiated after fluorescence is eliminated by the heat treatment at 200° C. shown in FIG. 2 and magnitude of fluorescence level belonging to Eu³⁺. That is, this fact indicates the possibility of usage as a rewritable recording material.

FIG. 4 shows the correlation between irradiation time when light of 6 W and wavelength 254 nm is irradiated to a polyimide film containing Tb³⁺ obtained in Example 2 using an UV lamp and magnitude of fluorescence level belonging to Eu³⁺.

FIG. 5 shows that the magnitude of fluorescence level is saturated by 3 hours when light of 6 W and wavelength 254 nm is irradiated to a polyamide acid film containing Eu³⁺ obtained in Example 4 using an UV lamp.

FIG. 6 shows the fact that the light of 6 W and wavelength 254 nm is irradiated to a polyacrylic acid film containing Eu³⁺ obtained in Example 5 using an UV lamp and along with the increase of irradiation time, magnitude of fluorescence level belonging to Eu³⁺ is intensified, and the magnitude of fluorescence level is saturated by 24 hours.

FIG. 7 shows the SEM picture of polyacrylic acid fine particles containing Eu³⁺ obtained in Example 7.

FIG. 8 shows the process illustration of a producing process of polyimide fine particles containing a rare earth element ion, a fluorescence compound or an organic pigment by re-precipitation method relating the first invention of said second subject, and in A, B processes prescribed amount of polyamide acid solution 3 containing functionality providing component is poured into a poor solvent 1, and polyamide acid fine particles containing prescribed amount of said functionality providing subject is obtained by re-precipitation method. When solvent 3 is poured, said poor solvent is stirred by a stirrer 2.

FIG. 9 shows the SEM picture of polyimide fine particles containing Eu³⁺ obtained in Example 8.

FIG. 10 shows the fluorescence spectrum when polyimide fine particles containing Eu³⁺ obtained in Example 8 is irradiated by exited light of wavelength 280 nm.

FIG. 11 shows the fluorescence spectrum when polyimide fine particles containing Tb³⁺ (a) and Ce³⁺ (b) obtained in Example 9 is irradiated by exited light of wavelength 280 nm.

FIG. 12 shows the SEM picture of polyimide fine particles containing Eu³⁺ obtained in Example 10 produced by using polyamide acid-Eu(NO₃)₃ wherein blending amount of Eu³⁺ is 1 wt % (a), 5 wt % (b) and 10 wt % to polyamide acid.

FIG. 13 shows the fluorescence spectrum when polyimide fine particles containing Eu³⁺ obtained in Example 10 produced by using polyamide acid-Eu(NO₃)₃ wherein blending amount of Eu³⁺ is 1 wt % (a), 5 wt % (b) and 10 wt % to polyamide acid is irradiated by exited light of wavelength 280 nm.

FIG. 14 shows the SEM picture of polyimide fine particles containing quinacridone obtained in Example 11.

FIG. 15 shows the SEM picture of polyimide fine particles containing Eu³⁺ obtained by adjusting the temperature of cyclohexane, which is a poor solvent to 10° C. (a), 25° C. (b) and 40° C. (c) in Example 13.

FIG. 16 shows the SEM picture of polyimide fine particles containing Fe((NO₃)₃ (a) or FeCl₃ (b) or CuSO₄ (c) as a compound containing transition metal obtained in Example 15.

The present invention will be illustrated more in detail.

In the invention relating aforementioned 1^{st} subject,

A. It is important that the material composing a rare earth ion to exist in a polymer material possessing a carbonyl group, to form different coordination states by light irradiation and to maintain the state stable at room temperature. As a rare earth element to form said coordination state, an element belonging to lanthanide, desirably, an element whose atomic number is from 58 to 70, more desirably, an element selected from the group consisting of Eu, Tb, Gd and Ce. These elements have a specific fluorescence peak wavelength and records corresponding to multiple transitions characterizing that the intensify of magnitude of fluorescence level are different.

B. It is important that the polymer material to maintain an rare earth element ion of said coordination state stable at room temperature, and since it is conjectured that the coordinate bond state of a rare earth element ion and oxygen, namely, “rare earth element ion—O” is desirable to maintain said multiple coordinate bond state, a polymer which possesses a carbonyl group in a main or a side chain of the polymer is used as a desirable polymer.

From the electronic theory relating to the coordinate bond state, it is important that energy gap of HOMO and LUMO of polymer, ground state of rare earth element ion and energy gap of exiting state are corresponding to said condition, for realization of energy transportation between the polymer and the rare earth element ion.

B-1. As a desirable polymer, polyimide can be mentioned first. As tetracarboxylic acid or dianhydride thereof, 3,3′-4,4′-benzophenon tetracarboxylic acid (BTDA), 3,3′-4,4′-tetracarboxybiphenyl, 2,2-(3,4-dicarboxyphenyl)-1,1,1,3,3,3-hexafluoropropane and dianhydride thereof can be mentioned.

B-2. As a diamine to form polyamide acid, which is a precursor of polyimide, by reacting with said tetracarboxylic acid or dianhydride thereof and forms polyimide by followed imidization, 4,4′-diaminodiphenylether, 4,4′-bis(4-aminophenoxy)biphenyl, 1,4-bis(4-aminophenoxy)benzene, 1,3-bis(4-aminophenoxy)benzene, 1,4-diaminobenzene, 4,4′methylenebis(methylcyclohexylamine), 4,4′methylenebis(ethylcyclohexylamine) can be mentioned.

B-3. As another polymer, an addition polymerized polymer of monomer which possesses ethylene unsaturated bond such as polyacrylic acid or polymethylmethacrylate (PMMA) having a carboxylic group or an ester group in a side chain.

C. Particle size is important from the view point of effective use of recording light. It is possible to obtain a particle of 5 nm particle size in which said rare earth element ions are uniformly dispersed, by preparing a solution in which said rare earth element is existing as an ion by dissolving said polymer and rare earth element compound, pouring said solution into a poor solvent of these two components and produce fine particles, that is, by means of a reprecipitation method.

D. Method for production of a recording material

As a method for production of above mentioned photomemory material, following production steps are used. Namely, 1-10 weight % of rare earth salt is blended to a polymer possessing a carbonyl group in a main or a side chain of the polymer, said polymer is dissolved in a solvent, desirably in a polar solvent for the purpose to exist said rare earth salt as an ion in the solution, by 0.1-15 weight % concentration, obtained polymer solution is formed to a polymer film containing rear earth salt by a spin coating method, a dip coating method or a casting method which are public known methods of polymer film, or said obtained polymer solution is poured into a poor solution selected from a group consisting of fatty acid solvent (decalin, hexane), alicyclic solvent (cyclohexane), CS₂ and a mixture of 2 or more kinds of these solvents and the temperature of said solvent is adjusted to from −20° C. to 60° C. so as to form polymer fine particles whose particle size is from 5 nm to 10000 nm, and obtained dispersion of polymer fine particles is formed to a polymer fine particle film containing rare earth salt by similar method to above mentioned polymer film producing method or by an electrodeposition method.

As the polar solvent, acetone, methylethylketone, tetrahydrofuran, dioxane, acetonitrile, alcohols (methanol, ethanol, isopropanol or others), N,N-dimethylacetoamide, dimethylformamide or N-methylpyrrolidone (NMP) can be mentioned.

For the production of a photomemory material whose polymer material is polyimide, it is desirable to prepare a film or fine particles using polyamide acid (another name is polyamic acid) which is a precursor of polyimide as a starting material, then to imidize the obtained film or fine particles physically or chemically.

E. By irradiating light having wavelength corresponding to the coordinate bond state of a polymer possessing carbonyl group, rare earth element ion and oxygen mentioned in item B, for example, light having wavelength of 254 nm or 304 nm to the produced polymer film containing rare earth salt or polymer fine particle film containing rare earth salt according to above mentioned production method have a feature to carry out stable photomemory wherein magnitude of fluorescence level of rare earth ion is intensified depending on irradiation amount of light at room temperature. Further, by carrying out a heat treatment at the temperature lower than glass transition point of said rare earth salt containing polymer, the magnitude of fluorescence level can be reduced or eliminated to the state due to said heat treatment temperature.

F. Desirably, as a rare earth salt used for the production the photomemory material, chloride, nitride or cyanide of Eu³⁺ or Tb³⁺ can be mentioned. Method for production of a material by which multiple bit recording utilizing said increase of said fluorescence characteristic to the film whose polymer is polyimide, polyacrylic acid or polymethylmethacrylic (PMMA) is possible.

In the Invention Relating Aforementioned 2^{nd} Subject,

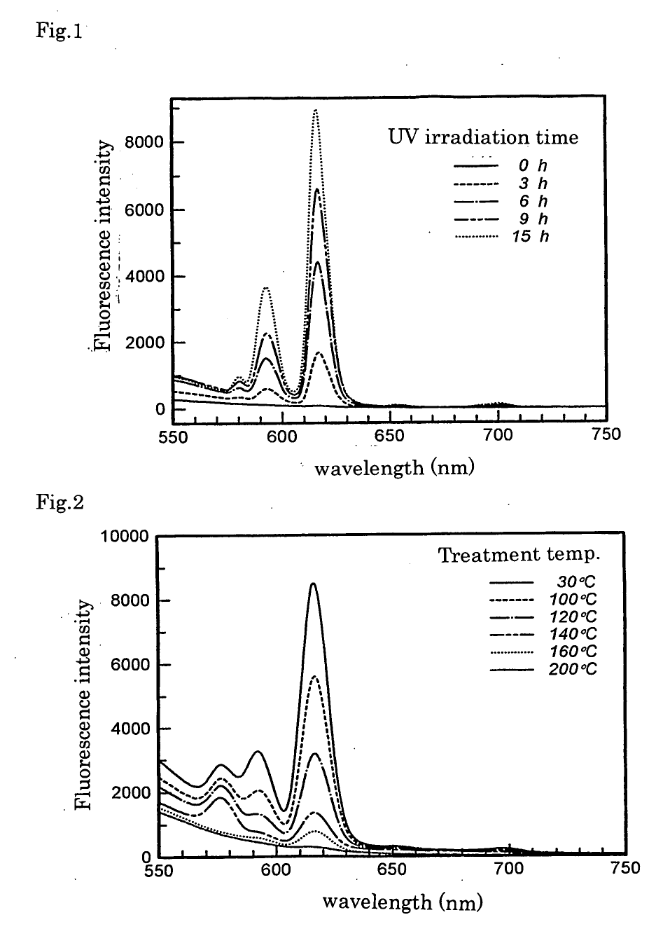

2-A. In the present invention, as a reprecipitation method which forms polyamide acid fine particles to which functionality providing component is blended, a method to produce fine particles, in particular, fine particles of polyimide by a conventional reprecipitation method can be applied except a point to use a solution prepared by blending a compound which forms a rare earth element ion or a transition metal ion, which is said functionality providing component or a pigment (as an expression to represent said blended compounds, an expression of functionality providing component can be used) to a polyamide acid solution as a solution to be poured into a poor solution. As shown in FIG. 1, which is a process illustrating view of a reprecipitation method, in A and B processes, solution of polyamide acid 3 containing prescribed amount of a functionality providing component, e.g. 0.1-10 weight % is poured into poor solution 1 and polyamide acid fine particles containing prescribed amount of the functionality providing component is obtained by reprecipitation method. Stirring condition of a stirred 2 to stir the poor solvent when solution 3 is poured in should be accomplish the most suited condition according to a scale, however, in a case of beaker scale, 100-3000 rpm is desirable. Further, for the purpose to improve the dispersability of hybrid fine particles containing prepared functionality providing component, 0.1 weight % of a neutral polymer surface active agent (Acrydic: product of DIC Co., Ltd), which is polyacrylic ester series, can be contained. Then, in C process, acetic acid anhydride/pyridine mixed solvent 5 is added, under constant stirring, wherein stirring condition is depending on a scale and in a beaker scale stirred by 100-3000 rpm, imidized chemically and polyamide fine particles dispersion 6 containing the functionality providing component is obtained. The imidization process can be a thermal imidization or said chemical imidization, for example, after chemical imidization using acetic acid anhydride/pyridine mixed solvent a thermal imidization can be carried out.

2-B. As a solvent for polyamide acid (can be called as polyamic acid), conventional organic solvent, which is specified as a poor solvent to polyamide acid used for a reprecipitation method and a functionality providing subject and has compatibility with a solvent of said polyamide acid, can be used. As the specific example, acetone, chloroform, methylethylketone, tetrahydrofurane, dioxane, acetonitrile, alcohols (methanol, ethanol, isopropanol or others), N,N-dimethylacetoamide, dimethylformamide or N-methylpyrrolidone (NMP) can be mentioned, and N,N-dimethylacetoamide, NMP or dimethylformamide is preferably used.

Solution concentration of polyamide acid is a big factor which effects to a formed particle size. Especially, when the molecular weight of polyamide acid is large, the effect of solution concentration to a particle size becomes large. The desirable concentration of polyamide acid is 0.1-15.0 weight %, and when the molecular weight is large, 0.5 weight % is desirable. Further, when the concentration becomes high, 4.0 weight %, in the case of hybrid fine particles possessing fluorescence characteristic obtained by blending the rare earth ion forming compound, the tendency of flocculation is observed

2-C. As a solvent which has a compatibility with a solvent of the polyamide acid and is also a poor solvent to the polyamide acid, hexane (aliphatic solvents), decalin or cyclohexane (alicyclic solvents), benzene or toluene (aromatic solvents), water, alcohols, carbon disulfide or mixture of two or more kinds of these compounds can be used, however, among these compounds, alicyclic solvents and mixed solvent of alicyclic solvents and carbon disulfide are preferably used.

2-D. Temperature of the poor solvent is sufficient by room temperature, however, by adjusting the temperature condition, the particle size of the formed fine particles can be adjusted and is possible to produce polyamide acid hybrid fine particles possessing desired fluorescence characteristic can be obtained. However, in a case of temperature lower than 30° C., there is a tendency that the particle size of polyamide acid hybrid fine particles becomes larger and polyamide acid hybrid fine particles having 10000 nm fluorescence characteristic in maximum is formed.

2-E. As tetracarboxylic or dianhydride thereof, which is used to form polyimide fine particles an to form said polyimide, 3,3′-4,4′-benzophenone tetracarboxylic acid (BTDA), 3,3′-4,4′-tetracarboxybiphenyl, 2,2-(3,4-dicarboxyphenyl)-1,1,1,3,3,3-hexafluoropropane and dianhydride thereof can be mentioned.

Further, as a diamine which forms polyimide acid being a polyimide precursor by reacting with said tetracarboxylic or dianhydride thereof and forms polyimide by followed imidizing process, 4,4′-diaminodiphenylether, 4,4′-bis(4-aminophenoxy) benzene, 1,3′-bis(4-aminophenoxy) benzene, 1,4-diaminobenzene or 4,4′-methylenebis(ethylcyclohexylamine) can be mentioned.

The molecule weight of polyimide, basically, voluntarily selected according to a relationship between uses of polyimide hybrid fine particles obtained by said functionality providing subject, and for the purpose to produce of desired fine particles stable, it is desirable that average molecular weight is in the region of 8000-220000.

F. As a functionality providing compound, rare earth elements, desirably lanthanide elements, more desirably a compound of elements whose atomic number is 58-70, a compound of transition metal, an organic dye (pigment), quinacridone, titanylphthalocyanine can be mentioned.

### EXAMPLE

The present invention will be illustrated in detail according to Examples. And is tending to make the usefulness of the present invention, and is not tending to restrict the scope or and claims of the present invention.

### Example 1

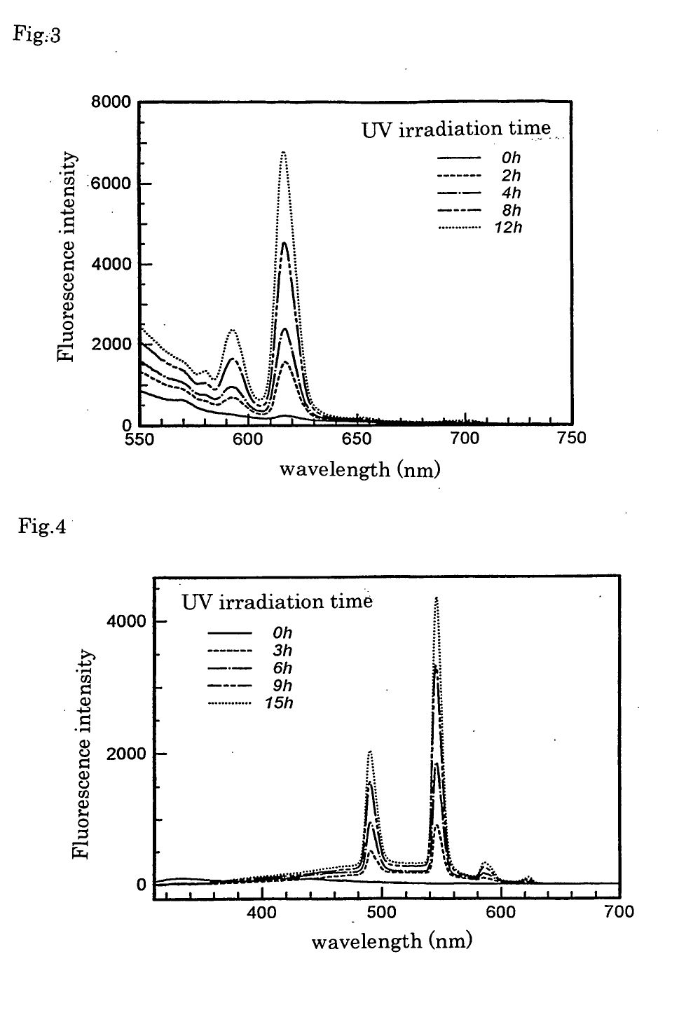

Polyamide acid (average molecular weight: 122955) obtained by polymerization between 2,2-(3,4-dicarboxyphenyl)-1,1,1,3,3,3-hexafluoro propane dianhydride and 4,4-diaminodiphenylether are dissolved in acetone so as the concentration of the polyamide acid to be 0.7 weight %. Eu(NO₃)₃ is added to said solution so as the blending amount of Eu³⁺ to said dissolved amount of polyamide acid to be 1 weight %, 5 weight %, 10 weight % /polyamide acid, and polyamide acid-Eu(NO₃)₃ acetone solution is prepared. Then 0.01 ml of said solution is cast on a quartz board of 20×10 mm, after spin coating or dip coating by 3000 rpm and dried. Thus a polyamide film containing Eu³⁺ is produced. This film is maintained in the atmosphere of 350° C. for 2 hours so that thermal imidization is completed and polyimide film containing Eu³⁺ is obtained. For the purpose to investigate photomemory characteristic of the obtained polyimide film containing Eu³⁺, light of 6 W and wavelength 254 nm is irradiated using a UV lamp, and it is confirmed that magnitude of fluorescence level belonging to Eu³⁺ enhances along with the increase of irradiation time. Results are shown in FIG. 1. Regarding saturated intensity, polyimide fine particles containing 5 weight % Eu³⁺ indicates the highest value, and become 400 times when compared with that of before UV lamp irradiation. By carrying out heat treatment on a polyimide fine particle film containing Eu³⁺ in which magnitude of fluorescence level is saturated for 5 minutes, magnitude of fluorescence level decreases along with elevation of heat treatment temperature and eliminated completely at 200° C. Results are shown in FIG. 2. After fluorescence is eliminated, magnitude of fluorescence level is intensified again by irradiation of UV light. Results are shown in FIG. 3.

From this phenomenon, it is understood that the polyimide fine particle film containing Eu³⁺ is useful as a re-writable photomemory material.

### Example 2

Polyamide acid (average molecular weight: 122955) obtained by polymerization between 2,2-(3,4-dicarboxyphenyl)-1,1,1,3,3,3-hexafluoro propane dianhydride and 4,4-diaminodiphenylether are dissolved in NMP so as the concentration of the polyamide acid to be 0.7 weight %. Tb(NO₃)₃ is added to said solution so as the blending amount of Tb³⁺ to said dissolved amount of polyamide acid to be 5 weight %/polyamide acid, and NMP solution of polyamide acid-Tb(NO₃)₃ is prepared. Then 0.01 ml of said solution is cast on a quartz board of 20×10 mm, after spin coating or dip coating by 3000 rpm and dried. Thus a polyamide film containing Tb³⁺ is produced. This film is maintained in the atmosphere of 350° C. for 2 hours so that thermal imidization is completed, then light of 6 W and wavelength 254 nm is irradiated on the film using a UV lamp, and it is confirmed that magnitude of fluorescence level belonging to Tb³⁺ enhances along with the increase of irradiation time and saturated by approximately 15 hours. Results are shown in FIG. 4. By carrying out heat treatment on a polyimide fine particle film containing Tb³⁺ in which magnitude of fluorescence level is saturated for 5 minutes, magnitude of fluorescence level decreases along with elevation of heat treatment temperature and eliminated completely at 200° C. After fluorescence is eliminated, magnitude of fluorescence level is intensified again by irradiation of UV light.

From this phenomenon, it is understood that the polyimide fine particle film containing Tb³⁺ is useful as a re-writable photomemory material.

### Example 3

Polyamide acid (average molecular weight: 122955) obtained by polymerization between 2,2-(3,4-dicarboxyphenyl)-1,1,1,3,3,3-hexafluoro propane dianhydride and 4,4-diaminodiphenylether are dissolved in acetone so as the concentration of the polyamide acid to be 0.7 weight %. Eu(NO₃)₃ is added to said solution so as the blending amount of Eu³⁺ to said dissolved amount of polyamide acid to be 5 weight % /polyamide acid, and polyamide acid-Eu(NO₃)₃ acetone solution is prepared. Then 0.01 ml of said solution is cast on a quartz board of 20×10 mm, after spin coating or dip coating by 3000 rpm and dried. Thus a polyamide film containing Eu³⁺ is produced. This film is maintained in the atmosphere of 350° C. for 2 hours so that thermal imidization is completed and polyimide film containing Eu³⁺ is obtained. For the purpose to investigate photomemory characteristic of the obtained polyimide film containing Eu³⁺, light of 6 W and wavelength 304 nm is irradiated using a UV lamp, and it is confirmed that magnitude of fluorescence level belonging to Eu³⁺ enhances along with the increase of irradiation time, and the magnitude of fluorescence level is saturated by approximately 15 hours. By carrying out heat treatment on a polyimide fine particle film containing Eu³⁺ in which magnitude of fluorescence level is saturated for 5 minutes, magnitude of fluorescence level decreases along with elevation of heat treatment temperature and eliminated completely at 200° C. After fluorescence is eliminated, magnitude of fluorescence level is intensified again by irradiation of UV light.

From this phenomenon, it is understood that the polyimide fine particle film containing Eu³⁺ is useful as a re-writable photomemory material.

### Example 4

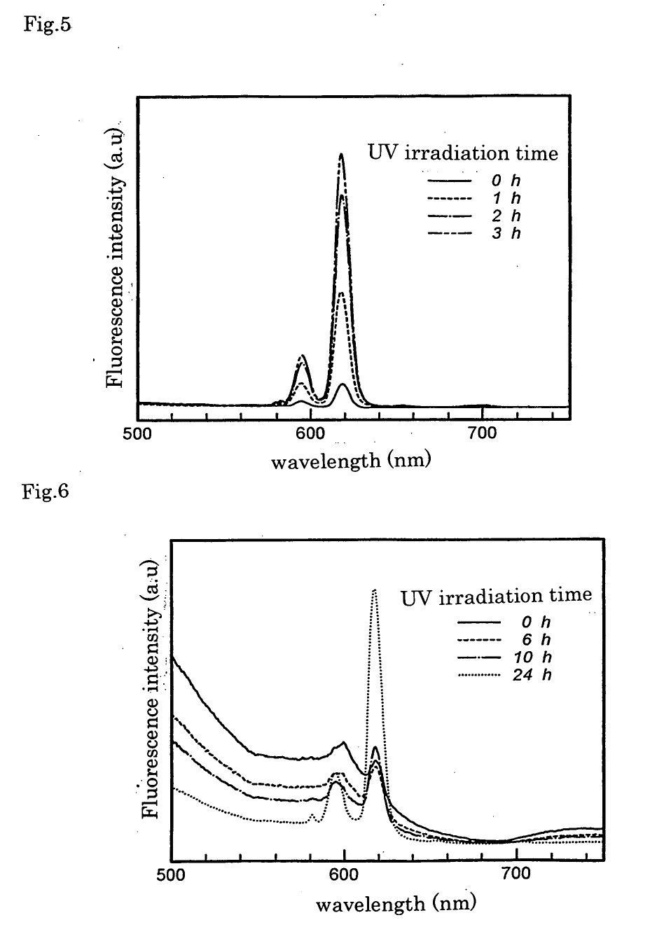

Polyamide acid obtained by polymerization between 3,3′-4,4′-tetracarboxybiphenyl dianhydride and 1,4-diaminobenzene are dissolved in NMP so as the concentration to be 1 weight %. Eu(NO₃)₃, or Tb(NO₃)₃ or Sm(NO₃)₃ or Er(NO₃)₃ is added to said solution so as the blending amount of Eu³⁺ or Tb³⁺ or Sm³⁺ or Er³⁺ to said dissolved amount of polyamide acid to be 5 weight % /polyamide acid, solution of polyamide acid-Eu(NO₃)₃ and polyamide acid-Tb(NO₃)₃ and polyamide acid-Sm(NO₃)₃ and polyamide acid-Er(NO₃)₃ are prepared. Then 0.01 ml of said solution is cast on a quartz board of 20×10 mm, after spin coating or dip coating by 3000 rpm and dried. Thus a polyamide film containing Eu³⁺ is produced. For the purpose to investigate photomemory characteristic of the obtained polyimide film containing Eu³⁺, light of 6 W and wavelength 254 nm is irradiated using a UV lamp, and it is confirmed that magnitude of fluorescence level belonging to Eu³⁺ enhances along with the increase of irradiation time, and the magnitude of fluorescence level is saturated by approximately 3 hours. Results of polyamide acid film containing Eu³⁺ is shown in FIG. 5. By carrying out heat treatment on a polyamide acid fine particle film containing Eu³⁺ in which magnitude of fluorescence level is saturated for 5 minutes, magnitude of fluorescence level decreases along with elevation of heat treatment temperature and eliminated completely at 200° C. After fluorescence is eliminated, magnitude of fluorescence level is intensified again by irradiation of UV light. In cases of polyamide film containing Tb³⁺ or Sm³⁺ or Er³⁺, same characteristic to the case of Eu³⁺ are obtained.

### Example 5

Polyacrylic acid (molecular weight: 450000) is dissolved in NMP so as the concentration to be 1 weight %. Eu(NO₃)₃ is added to said solution so as the blending amount of Eu³⁺ to said dissolved amount of polyacrylic acid to be 5 weight % /polyacrylic acid, and polyacrylic acid-Eu(NO₃)₃ solution is prepared. Then 0.01 ml of said solution is cast on a quartz board of 20×10 mm, after spin coating or dip coating by 3000 rpm and dried. Thus a polyacrylic acid film containing Eu³⁺ is produced. For the purpose to investigate photomemory characteristic of the obtained polyacrylic film containing Eu³⁺, light of 6 W and wavelength 254 nm is irradiated using a UV lamp, and it is confirmed that magnitude of fluorescence level belonging to Eu³⁺ enhances along with the increase of irradiation time, and the magnitude of fluorescence level is saturated by approximately 24 hours. Results are shown in FIG. 6. By carrying out heat treatment on a polyacrylic acid film containing Eu³⁺ in which magnitude of fluorescence level is saturated for 5 minutes, magnitude of fluorescence level decreases along with elevation of heat treatment temperature and eliminated completely at 140° C. After fluorescence is eliminated, magnitude of fluorescence level is intensified again by irradiation of UV light.

### Example 6

Poly(methyl methacrylate) (molecular weight: 350000) is dissolved in NMP so as the concentration to be 1 weight %. Solution is prepared so as the blending amount of Eu³⁺ to said dissolved amount of poly(methyl methacrylate) to be 5 weight % /PMMA. Then 0.01 ml of said solution is cast on a quartz board of 20×10 mm, after spin coating or dip coating by 3000 rpm and dried. Thus a PMMA film containing Eu³⁺ is prepared. For the purpose to investigate photomemory characteristic of the obtained PMMA film containing Eu³⁺, light of 6 W and wavelength 254 nm is irradiated using a UV lamp, and it is confirmed that magnitude of fluorescence level belonging to Eu³⁺ enhances along with the increase of irradiation time, and the magnitude of fluorescence level is saturated by approximately 24 hours. Results are shown in FIG. 6. By carrying out heat treatment for 5 minutes on a PMMA film containing Eu³⁺ in which magnitude of fluorescence level is saturated, magnitude of fluorescence level decreases along with elevation of heat treatment temperature and eliminated completely at 160° C. After fluorescence is eliminated, magnitude of fluorescence level is intensified again by irradiation of UV light.

### Example 7

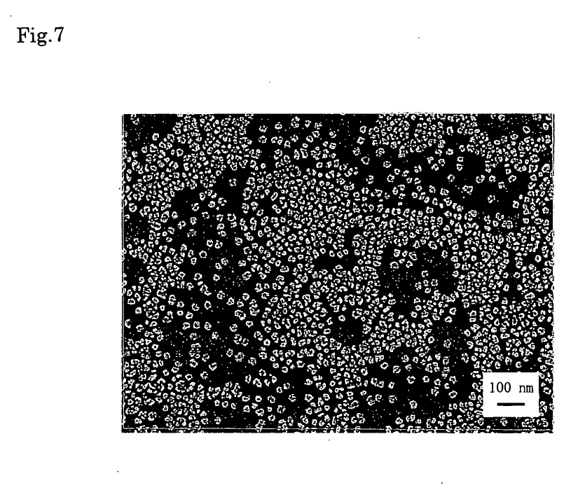

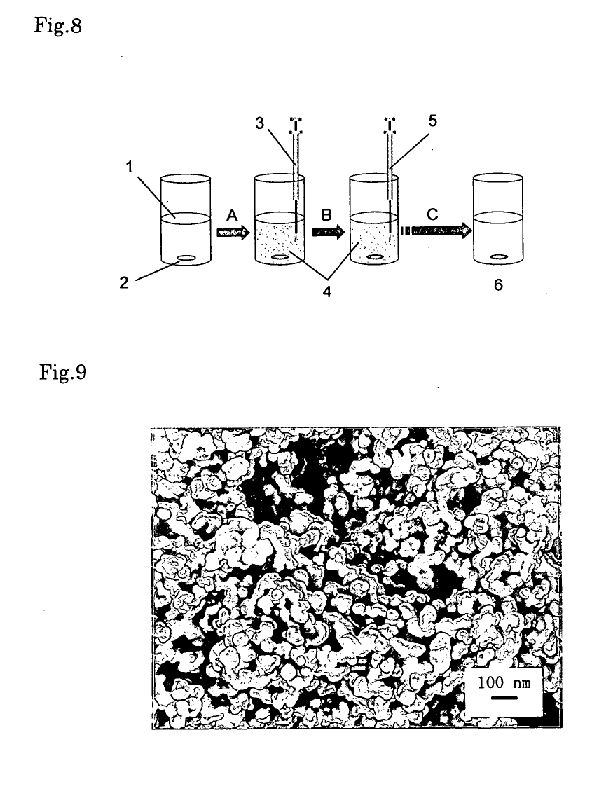

Polyacrylic acid (molecular weight: 450000) is dissolved in NMP so as the concentration to be 1 weight %. Eu(NO₃)₃ is added to said solution so as the blending amount of Eu³⁺ to said dissolved amount of polyacrylic acid to be 5 weight % /polyacrylic acid, and polyacrylic acid-Eu(NO₃)₃ solution is prepared. 0.1 ml of said solution is poured into 10 ml of cyclohexane (ACRYDIC: 0.1 weight % contained) using a micro syringe at room temperature stirring by 1500 rpm and polyacrylic acid fine particles containing Eu³⁺ is obtained. Observation results by a scanning electron microscope (SEM) are shown in FIG. 7. Film is obtained from said polyacrylic acid fine particles containing Eu³⁺ by a casting method or by an electrodeposition method (fine particles concentration in dispersion: 0.1-1 weight %, charge voltage:10-1000V/cm-⁻¹), and bulk molded product is produced by containing 0.2 g of the fine particles in a molding machine of 3 mm diameter and pressing. Then, for the purpose to investigate photomemory characteristic of the obtained polyacrylic acid film containing Eu³⁺, light of 6 W and wavelength 254 nm is irradiated using a UV lamp, and it is confirmed that magnitude of fluorescence level belonging to Eu³⁺ enhances along with the increase of irradiation time, and the magnitude of fluorescence level is saturated by approximately 24 hours. By carrying out heat treatment on a polyimide film containing Eu³⁺ in which magnitude of fluorescence level is saturated for 5 minutes, magnitude of fluorescence level decreases along with elevation of heat treatment temperature and eliminated completely at 140° C. After fluorescence is eliminated, magnitude of fluorescence level is intensified again by irradiation of UV light.

### Example 8

Polyamide acid (average molecular weight: 122955) obtained by polymerization between 2,2-(3,4-dicarboxyphenyl)-1,1,1,3,3,3-hexafluoro propane dianhydride and 4,4-diaminodiphenylether are dissolved in acetone and polyamide acid-acetone solution of 0.7 weight % is prepared. Eu(NO₃)₃ is added to said solution so as the blending amount of Eu³⁺ to said dissolved amount of polyamide acid to be 5 weight % /polyamide acid, and polyamide acid-Eu(NO₃)₃ acetone solution is prepared. Then 0.1 ml of said polyamide acid-Eu(NO₃)₃ solution is poured into 10 ml of cyclohexane (afore mentioned ACRYDIC: 0.1 weight % contained) using a micro syringe at room temperature stirring by 1500 rpm and polyamide acid fine particles containing Eu³⁺ dispersion is obtained.

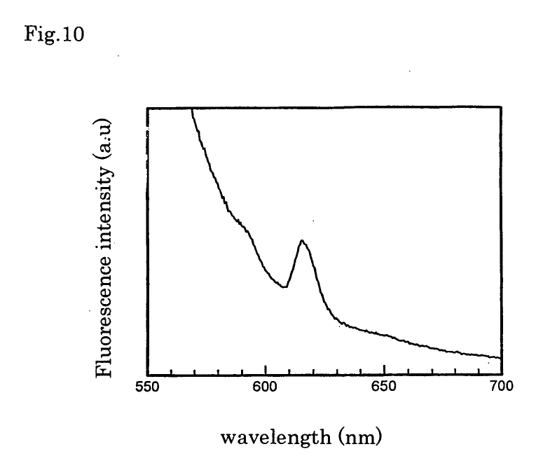

To the obtained polyamide acid fine particles containing Eu³⁺ dispersion, 0.1 ml of mixed solution of pyridine/acetic anhydride whose molar ratio is 1/1 is added under constant stirring condition and maintained for 2 hours so as to complete chemical imidization, then polyimide fine particles containing Eu³⁺ is obtained. Obtained polyimide fine particles containing Eu³⁺ is observed by a scanning electron microscope (SEM). Results are shown in FIG. 9. When UV ray of excitation wavelength 280 nm is irradiated to the obtained polyimide fine particles containing Eu³⁺, fluorescence spectrum shown in FIG. 10 is obtained.

### Example 9

Polyamide acid (average molecular weight: 122955) obtained by polymerization between 2,2-(3,4-dicarboxyphenyl)-1,1,1,3,3,3-hexafluoro propane dianhydride and 4,4-diaminodiphenylether are dissolved in acetone and polyamide acid-acetone solution of 0.7 weight % is prepared. Tb(NO₃)₃ or Ce(NO₃)₃ is added to said solution so as the blending amount of Tb³⁺ (a) or Ce³⁺ (b) to dissolved amount of polyamide acid in said polyamide acid-acetone solution to be 5 weight % /polyamide acid, and solution of polyamide acid-Tb³⁺ (a) or Ce³⁺ (b) is prepared. 0.1 ml of said solution of polyamide acid-Tb³⁺ (a) or Ce³⁺ (b) is poured into 10 ml of cyclohexane (afore mentioned ACRYDIC: 0.1 weight % contained) using a micro syringe at room temperature stirring by 1500 rpm and polyamide acid fine particles dispersion containing Tb³⁺ or Ce³⁺ is obtained.

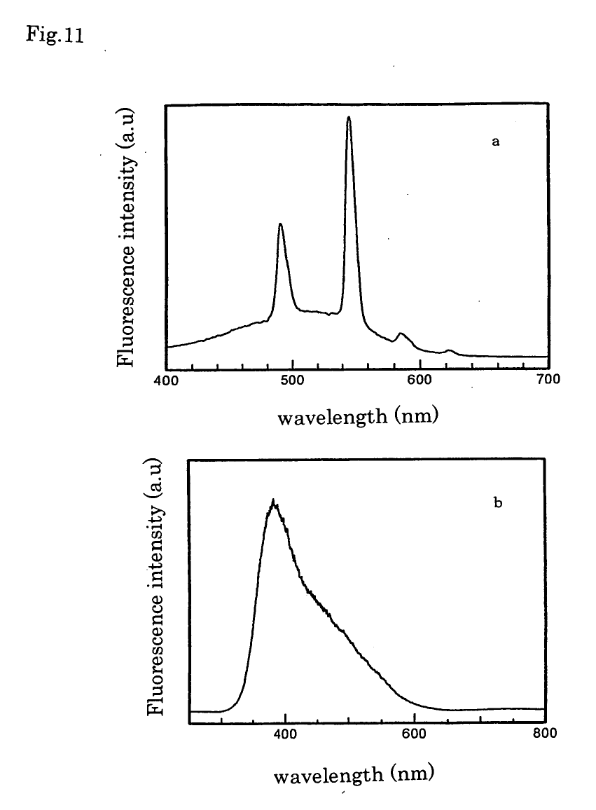

To the obtained polyamide acid fine particles dispersion containing Tb³⁺ or Ce³⁺, 0.1 ml of mixed solution of pyridine/acetic anhydride whose molar ratio is 1/1 is added under constant stirring condition and maintained for 2 hours so as to complete chemical imidization, then polyimide fine particles containing Tb³⁺ or Ce³⁺ is obtained. When UV ray of excitation wavelength 280 nm is irradiated to the obtained polyimide fine particles containing Tb³⁺ or Ce³⁺, fluorescence spectrum shown in FIG. 11 is obtained.

### Example 10

Polyamide acid (average molecular weight: 122955) obtained by polymerization between 2,2-(3,4-dicarboxyphenyl)-1,1,1,3,3,3-hexafluoro propane dianhydride and 4,4-diaminodiphenylether are dissolved in NMP and 0.7 weight % polyamide acid-NMP solution is prepared. Eu(NO₃)₃ is added to said solution so as the blending amount of Eu³⁺ to said dissolved amount of polyamide acid to be 1 weight % (a), 5 weight % (b), 10 weight % (c)/polyamide acid, and polyamide acid-Eu(NO₃)₃ solution is prepared. 0.1 ml of said solutions are poured into 10 ml of cyclohexane (ACRYDIC: 0.1 weight % contained) using a micro syringe at room temperature stirring by 1500 rpm and polyamide acid fine particles dispersions containing Eu³⁺ of said concentration are prepared.

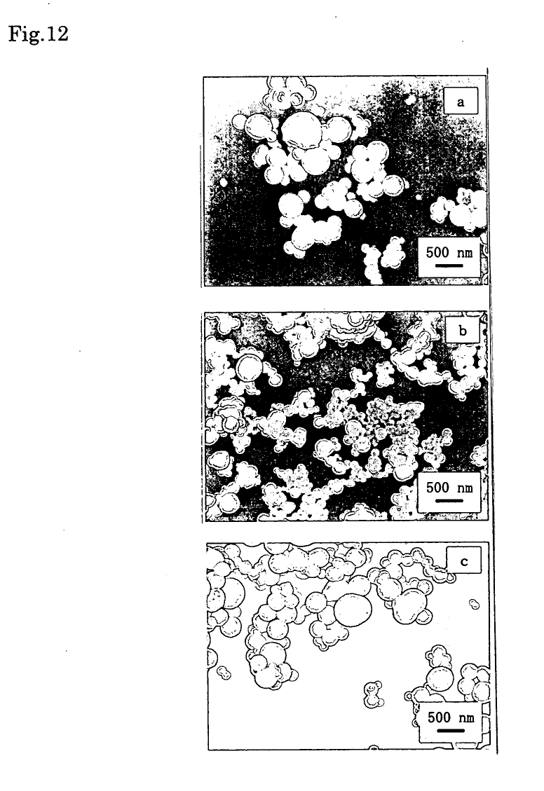

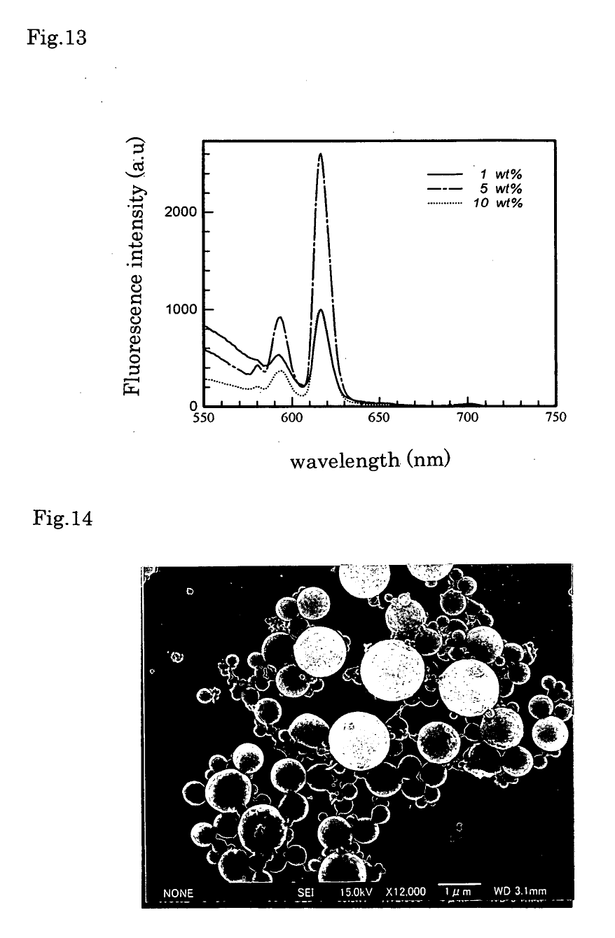

To the obtained polyamide acid fine particles dispersion containing Eu³⁺, 0.1 ml of mixed solution of pyridine/acetic anhydride whose molar ratio is 1/1 is added under constant stirring condition and maintained 2 hours so as to complete chemical imidization, then maintained at 270° C. for 3 hours so as to complete thermal imidization, then polyimide fine particles containing Eu³⁺ is obtained. The particle size of obtained polyimide fine particles is not depending on Eu³⁺ contents and becomes almost constant. Each polyimide fine particles containing Eu³⁺ are observed by a scanning electron microscope (SEM). Results are shown in FIG. 12. According to measuring results of fluorescence spectrum at excitation wavelength 280 nm, magnitude of fluorescence level of polyimide fine particles containing 5 weight % of Eu³⁺ is strongest. Fluorescence spectrum at excitation wavelength 280 nm is shown in FIG. 13.

### Example 11

Polyamide acid (average molecular weight: 122955) obtained by polymerization between 2,2-(3,4-dicarboxyphenyl)-1,1,1,3,3,3-hexafluoro propane dianhydride and 4,4-diaminodiphenylether are dissolved in NMP and 0.7 weight % polyamide acid-NMP solution is prepared. Solution characterized that the blending amount of quinacridone or titanylphthalocyanine to polyamide acid in said polyamide acid-NMP solution to be 10 weight % /polyamide acid is prepared. 0.1 ml of the obtained polyamide acid-quinacridone or polyamide acid-perylen of polyamide acid-titanylphthalocyanine is poured into 10 ml of cyclohexane (afore mentioned ACRYDIC: 0.1 weight % contained) using a micro syringe at room temperature stirring by 1500 rpm and polyamide acid fine particles dispersion containing quinacridone or perylene or titanylphthalocyanine is prepared.

To the obtained polyamide acid fine particles dispersion containing quinacridone or perylene or titanylphthalocyanine, 0.1 ml of mixed solution of pyridine/acetic anhydride whose molar ratio is 1/1 is added under constant stirring condition and maintained for 2 hours so as to complete chemical imidization, then maintained at 270° C. for 3 hours so as to complete thermal imidization, and polyimide fine particles containing quinacridone or perylene or titanylphthalocyanine is obtained. Obtained polyimide fine particles containing quinacridone is observed by a scanning electron microscope (SEM). Results are shown in FIG. 14. The polyimide fine particles containing quinacridone indicates red color, and by the measurement of absorption spectrum, an absorption is observed in the range from 500 nm to 600 nm.

### Example 12

Polyamide acid (average molecular weight: 90000) obtained by polymerization between 3,3′-4,4′-tetracarboxybiphenyl dianhydride and 1,4-diaminobenzene is dissolved in NMP and 0.7 weight % polyamide acid-NMP solution is prepared. Eu(NO₃)₃ is added to said solution so as the blending amount of Eu³⁺ to said dissolved amount of polyamide acid to be 5 weight % /polyamide acid, and solution is prepared. Then 0.1 ml of said polyamide acid-Eu(NO₃)₃ solution is poured into 10 ml of cyclohexane (afore mentioned ACRYDIC: 0.1 weight % contained) using a micro syringe at room temperature stirring by 1500 rpm and polyamide acid fine particles containing Eu³⁺ dispersion is prepared.

To the obtained polyamide acid fine particles dispersion containing Eu³⁺ , 0.1 ml of mixed solution of pyridine/acetic anhydride whose molar ratio is 1/1 is added under constant stirring condition and maintained for 2 hours so as to complete chemical imidization, then polyimide fine particles containing Eu³⁺ is obtained. The obtained polyimide fine particles containing Eu³⁺ indicates fluorescence by 280 nm excitation. Fluorescence characteristic is not different from that of Example 10.

### Example 13

Polyamide acid (average molecular weight: 122955) obtained by polymerization between 2,2-(3,4-dicarboxyphenyl)-1,1,1,3,3,3-hexafluoro propane dianhydride and 4,4-diaminodiphenylether are dissolved in NMP and 0.7 weight % polyamide acid-NMP solution is prepared. EuCl₃ is added to said solution so as the blending amount of Eu³⁺ to said dissolved amount of polyamide acid-NMP solution to be 5 weight % /polyamide acid, and solution of polyamide acid-EuCl₃ is prepared. 0.1 ml of said solution of polyamide acid-EuCl₃ are poured into 10 ml of 10°C.(a), 25°C.(b) and 40°C.(c) of cyclohexane (ACRYDIC: 0.1 weight % contained) using a micro syringe at room temperature stirring by 1500 rpm and polyamide acid fine particles dispersions containing Eu³⁺ are prepared.

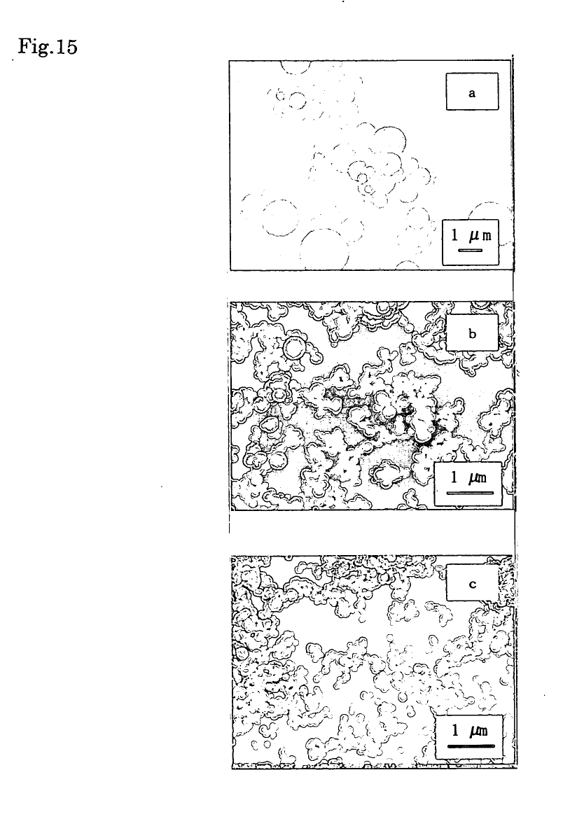

To the obtained polyamide acid fine particles dispersion containing Eu³⁺, 0.1 ml of mixed solution of pyridine/acetic anhydride whose molar ratio is 1/1 is added under constant stirring condition and maintained for 2 hours so as to complete chemical imidization, then polyimide fine particles containing Eu³⁺ maintaining particle size of 100 nm are obtained. Obtained polyimide particles containing Eu³⁺ are observed by a scanning electron microscope (SEM). Results are shown in FIG. 15. All of obtained polyimide fine particles containing Eu³⁺ indicate fluorescence by 280 nm excitation.

### Example 14

Polyamide acid (average molecular weight: 122955) obtained by polymerization between 2,2-(3,4-dicarboxyphenyl)-1,1,1,3,3,3-hexafluoro propane dianhydride and 4,4-diaminodiphenylether are dissolved in NMP and 0.7 weight % polyamide acid-NMP solution is prepared. Eu(NO₃)₃ is added to said solution so as the blending amount of Eu³⁺ to said dissolved amount of polyamide acid-NMP solution to be 5 weight % /polyamide acid, and solution of polyamide acid-Eu(NO₃)₃ is prepared. 0.1 ml of said solution of polyamide acid-EuCI₃ are poured into 10 ml of cyclohexane (afore mentioned ACRYDIC: 0.1 weight % contained) to which CS₂ of various volume fractions using a micro syringe at room temperature stirring by 1000 rpm and polyamide acid fine particles dispersions containing Eu³⁺ are prepared. Particle size of formed polyamide acid fine particles containing Eu³⁺ become small along with the increase of the blending amount of CS₂.

To the obtained polyamide acid fine particles dispersion containing Eu³⁺, 0.1 ml of mixed solution of pyridine/acetic anhydride whose molar ratio is 1/1 is added under constant stirring condition and maintained 2 hours so as to complete chemical imidization, then maintained at 270° C. for 3 hours so as to complete thermal imidization, and polyimide fine particles containing Eu³⁺ maintaining particle size of above mentioned polyamide acid fine particles containing Eu³⁺ are obtained. All of obtained polyimide fine particles containing Eu³⁺ indicate fluorescence by 280 nm excitation.

Any changes of fluorescence characteristic of the obtained polyimide fine particles containing Eu³⁺ along with the change of particle size are not recognized.

### Example 15

Polyamide acid (average molecular weight: 122955) obtained by polymerization between 2,2-(3,4-dicarboxyphenyl)-1,1,1,3,3,3-hexafluoro propane dianhydride and 4,4-diaminodiphenylether are dissolved in NMP and 0.7 weight % polyamide acid-NMP solution is prepared. Fe(NO₃)₃ (a) or FeCl₃ (b) or CuSO₄ (c) is added to said solution so as the blending amount of Fe³⁺ or Cu²⁺ to said dissolved amount of polyamide acid-NMP solution to be 5 weight % /polyamide acid, and solutions are prepared.

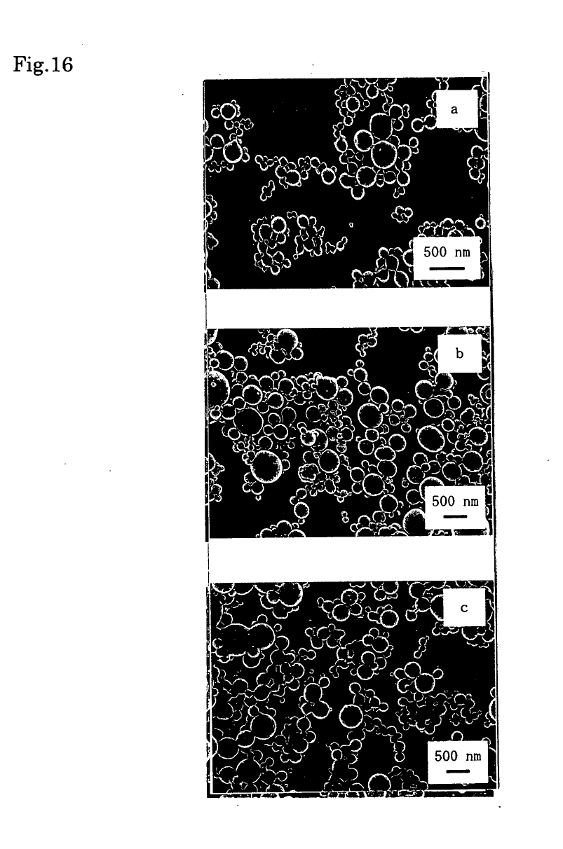

To the obtained polyamide acid fine particles dispersion containing Fe³⁺ or Cu²⁺, 0.1 ml of mixed solution of pyridine/acetic anhydride whose molar ratio is 1/1 is added under constant stirring condition and maintained 2 hours so as to complete chemical imidization, then maintained at 270° C. for 3 hours so as to complete thermal imidization, and polyimide fine particles containing Fe³⁺ or Cu²⁺ are obtained. Obtained polyimide particles containing Fe³⁺ or Cu²⁺ are observed by a scanning electron microscope (SEM). Results are shown in FIG. 16. Color of polyimide fine particles containing Fe³⁺ is light brown and color of polyimide fine particles containing Cu²⁺ is light blue. And these polyimide fine particles indicates paramagnetism.

### INDUSTRIAL APPRICABILITY

As illustrated in the 1^{st} subject of the present invention, a polymer material containing rare earth element enhances magnitude of fluorescence level corresponding to photo irradiation amount and the magnitude of fluorescence level can be maintained stable on room temperature atmosphere, and is possible to be used as a photomemory material. Further, since multiple record by dividing threshold value of irradiation amount of light is possible, said polymer material containing rare earth element can be used as a photomemory material of high density recording. Furthermore, since said photomemory can be recovered to the initial state by means of heat-treatment, polymer material containing rare earth element can be used as a re-writable recording material. And, by the 2^{nd} subject of the present invention, in a case when a compound which forms rare earth element ion, polyimide fine particles having 5 nm-10000 nm particle size which indicates fluorescence characteristic can be easily obtained, and in a case when a compound which forms transition metal ion, polyimide fine particles having 5 nm-10000 nm particle size indicating magnetism characteristic can be easily obtained, further, in a case when an organic pigment is blended, polyimide fine particles having 5 nm-10000 nm particle size which is colored or indicates non-linear characteristic can be easily obtained. Since, these fine particles are a hybrid material with polyimide, it is possible to provide an useful fine particle material with good heat resistance.

1. A photomemory material comprising a polymer with a carbonyl group in a main or a side chain of the polymer and a rare earth ion forming a complex of rare earth ion-polymer characterized in which magnitude of fluorescence level is intensified corresponding with applied photo irradiation intensity and is able to restore to initial state by applying heat treatment.

2. The photomemory material of claim 1, wherein the polymer possessing a carbonyl group is polyimide obtained by a reaction of tetracarboxylic acid or dianhydride thereof with diamine.

3. The photomemory material of claim 2, wherein the polymer possessing a carbonyl group is a polymer possessing a carboxylic group or an ester group thereof in a said side chain.

4. The photomemory material of claim 3, wherein the polymer possessing a carboxylic group or an ester group thereof in a said side chain is a polymer obtained by an addition polymerization of ethylene unsaturated group.

5. The photomemory material according to claim 1, wherein the rare earth element is selected from the group consisting of elements whose atomic number is from 58 to 70.

6. A photomemory material comprising, polymer fine particles containing a rare earth element ion whose particle size is from 5 nm to 10000 nm formed by dissolving a polymer possessing a carbonyl group in a main or a side chain of the polymer and a compound of a rare earth element which forms a rare earth element in a solvent which dissolves at least said two components and pouring a polymer film prepared by containing said rare earth element into the polymer formed from the solution and the solution into a poor solution of said two components, or a fine particle film formed from said fine particles or bulky molded product formed from said fine particles.

7. A method for production of polyimide fine particles with particle size in diameter from 5 nm to 10000 nm containing a rare earth ion or a transition metal ion or a pigment comprising, pouring polyamide acid solution prepared by dissolving a compound which forms a rare earth ion or a transition metal ion or a pigment compound in a solution which forms said ions to a poor solvent to said rare earth ion or transition metal ion or the pigment compound and the polyamide acid, forming fine particles of polyamide acid containing the rare earth ion or the transition metal ion or the pigment, then carrying out imidizing treatment on the formed fine particles of polyamide acid.

8. The method for production of polyimide fine particles with particle size in diameter from 5 nm to 10000 nm containing a rare earth ion or a transition metal ion or a pigment of claim 7 comprising, using polyamide acid solution dissolving a compound which forms 0.1-10 weight % of rare earth ion or transition metal ion or a pigment compound.

9. The method for production of polyimide fine particles with particle size in diameter from 5 nm to 10000 nm containing a rare earth ion or a transition metal ion or a pigment of claim 7 wherein a solvent to prepare polyamide acid solution is acetone, acetonitrile, tetrahydrofufuran or chloroform.

10. The method for production of polyimide fine particles with particle size in diameter from 5 nm to 10000 nm containing a rare earth ion or a transition metal ion or a pigment according to claim 7, wherein the poor solvent is decalin, cyclohexane, hexane, benzene, toluene, water, alcohols, CS₂ or mixture of two kinds or more.

11. The method for production of polyimide fine particles with particle size in diameter from 5 nm to 10000 nm containing a rare earth ion or a transition metal ion or a pigment according to claim 7, wherein the temperature of the poor solvent is adjusted to from −20° C. to 60° C.

12. The method for production of polyimide fine particles with particle size in diameter from 5 nm to 10000 nm containing a rare earth ion or a transition metal ion or a pigment according to claim 7, wherein the rare earth element ion is a element selected from the group consisting of the element whose atomic number is from 58 to 70.

13. The photomemory material according to claim 2 wherein the rare earth element is selected from the group consisting of elements whose atomic number is from 58 to 70.

14. The photomemory material according to claim 3 wherein the rare earth element is selected from the group consisting of elements whose atomic number is from 58 to 70.

15. The photomemory material according to claim 4 wherein the rare earth element is selected from the group consisting of elements whose atomic number is from 58 to 70.

16. The method for production of polyimide fine particles with particle size in diameter from 5 nm to 10000 nm containing a rare earth ion or a transition metal ion or a pigment of claim 8, wherein a solvent to prepare polyamide acid solution is acetone, acetonitrile, tetrahydrofufuran or chloroform.

17. The method for production of polyimide fine particles with particle size in diameter from 5 nm to 10000 nm containing a rare earth ion or a transition metal ion or a pigment according to claim 8, wherein the poor solvent is decalin, cyclohexane, hexane, benzene, toluene, water, alcohols, CS₂ or mixture of two kinds or more.

18. The method for production of polyimide fine particles with particle size in diameter from 5 nm to 10000 nm containing a rare earth ion or a transition metal ion or a pigment according to claim 9, wherein the poor solvent is decalin, cyclohexane, hexane, benzene, toluene, water, alcohols, CS₂ or mixture of two kinds or more.

19. The method for production of polyimide fine particles with particle size in diameter from 5 nm to 10000 nm containing a rare earth ion or a transition metal ion or a pigment according to claim 16, wherein the poor solvent is decalin, cyclohexane, hexane, benzene, toluene, water, alcohols, CS₂ or mixture of two kinds or more.

20. The method for production of polyimide fine particles with particle size in diameter from 5 nm to 10000 nm containing a rare earth ion or a transition metal ion or a pigment according to claim 8, wherein the temperature of the poor solvent is adjusted to from −20° C. to 60° C.

21. The method for production of polyimide fine particles with particle size in diameter from 5 nm to 10000 nm containing a rare earth ion or a transition metal ion or a pigment according to claim 9, wherein the temperature of the poor solvent is adjusted to from −20° C. to 60° C.

22. The method for production of polyimide fine particles with particle size in diameter from 5 nm to 10000 nm containing a rare earth ion or a transition metal ion or a pigment according to claim 16, wherein the temperature of the poor solvent is adjusted to from −20° C. to 60° C.

23. The method for production of polyimide fine particles with particle size in diameter from 5 nm to 10000 nm containing a rare earth ion or a transition metal ion or a pigment according to claim 10, wherein the temperature of the poor solvent is adjusted to from −20° C. to 60° C.

24. The method for production of polyimide fine particles with particle size in diameter from 5 nm to 10000 nm containing a rare earth ion or a transition metal ion or a pigment according to claim 17, wherein the temperature of the poor solvent is adjusted to from −20° C. to 60° C.

25. The method for production of polyimide fine particles with particle size in diameter from 5 nm to 10000 nm containing a rare earth ion or a transition metal ion or a pigment according to claim 18, wherein the temperature of the poor solvent is adjusted to from −20° C. to 60° C.

26. The method for production of polyimide fine particles with particle size in diameter from 5 nm to 10000 nm containing a rare earth ion or a transition metal ion or a pigment according to claim 19, wherein the temperature of the poor solvent is adjusted to from −20° C. to 60° C.

27. The method for production of polyimide fine particles with particle size in diameter from 5 nm to 10000 nm containing a rare earth ion or a transition metal ion or a pigment according to claim 8, wherein the rare earth element ion is a element selected from the group consisting of the element whose atomic number is from 58 to 70.

28. The method for production of polyimide fine particles with particle size in diameter from 5 nm to 10000 nm containing a rare earth ion or a transition metal ion or a pigment according to claim 9, wherein the rare earth element ion is a element selected from the group consisting of the element whose atomic number is from 58 to 70.

29. The method for production of polyimide fine particles with particle size in diameter from Snm to 10000 nm containing a rare earth ion or a transition metal ion or a pigment according to claim 16, wherein the rare earth element ion is a element selected from the group consisting of the element whose atomic number is from 58 to 70.

30. The method for production of polyimide fine particles with particle size in diameter from 5 nm to 10000 nm containing a rare earth ion or a transition metal ion or a pigment according to claim 10, wherein the rare earth element ion is a element selected from the group consisting of the element whose atomic number is from 58 to 70.

31. The method for production of polyimide fine particles with particle size in diameter from 5 nm to 10000 nm containing a rare earth ion or a transition metal ion or a pigment according to claim 17, wherein the rare earth element ion is a element selected from the group consisting of the element whose atomic number is from 58 to 70.

32. The method for production of polyimide fine particles with particle size in diameter from 5 nm to 10000 nm containing a rare earth ion or a transition metal ion or a pigment according to claim 18, wherein the rare earth element ion is a element selected from the group consisting of the element whose atomic number is from 58 to 70.

33. The method for production of polyimide fine particles with particle size in diameter from 5 nm to 10000 nm containing a rare earth ion or a transition metal ion or a pigment according to claim 19, wherein the rare earth element ion is a element selected from the group consisting of the element whose atomic number is from 58 to 70.

34. The method for production of polyimide fine particles with particle size in diameter from 5 nm to 10000 nm containing a rare earth ion or a transition metal ion or a pigment according to claim 11, wherein the rare earth element ion is a element selected from the group consisting of the element whose atomic number is from 58 to 70.

35. The method for production of polyimide fine particles with particle size in diameter from 5 nm to 10000 nm containing a rare earth ion or a transition metal ion or a pigment according to claim 20, wherein the rare earth element ion is a element selected from the group consisting of the element whose atomic number is from 58 to 70.

36. The method for production of polyimide fine particles with particle size in diameter from 5 nm to 10000 nm containing a rare earth ion or a transition metal ion or a pigment according to claim 21, wherein the rare earth element ion is a element selected from the group consisting of the element whose atomic number is from 58 to 70.

37. The method for production of polyimide fine particles with particle size in diameter from 5 nm to 10000 nm containing a rare earth ion or a transition metal ion or a pigment according to claim 22, wherein the rare earth element ion is a element selected from the group consisting of the element whose atomic number is from 58 to 70.

38. The method for production of polyimide fine particles with particle size in diameter from 5 nm to 10000 nm containing a rare earth ion or a transition metal ion or a pigment according to claim 23, wherein the rare earth element ion is a element selected from the group consisting of the element whose atomic number is from 58 to 70.

39. The method for production of polyimide fine particles with particle size in diameter from 5 nm to 10000 nm containing a rare earth ion or a transition metal ion or a pigment according to claim 24, wherein the rare earth element ion is a element selected from the group consisting of the element whose atomic number is from 58 to 70.

40. The method for production of polyimide fine particles with particle size in diameter from 5 nm to 10000 nm containing a rare earth ion or a transition metal ion or a pigment according to claim 25, wherein the rare earth element ion is a element selected from the group consisting of the element whose atomic number is from 58 to 70.

41. The method for production of polyimide fine particles with particle size in diameter from 5 nm to 10000 nm containing a rare earth ion or a transition metal ion or a pigment according to claim 26, wherein the rare earth element ion is a element selected from the group consisting of the element whose atomic number is from 58 to 70.
